(19) United States
(12) Patent Application Publication
(10) Pub. No.: US 2015/0209992 A1
(43) Pub. Date: Jul. 30, 2015

(54) PLASTIC MESH AND METHODS OF FORMING THE SAME

(71) Applicant: Automated Packaging Systems, Inc., Streetsboro, OH (US)

(72) Inventor: Hershey Lerner, Aurora, OH (US)

(21) Appl. No.: 14/598,887

(22) Filed: Jan. 16, 2015

Related U.S. Application Data
(60) Provisional application No. 61/931,155, filed on Jan. 24, 2014.

(51) Int. Cl. B29C 47/00

(52) U.S. Cl. CPC B29C 47/0021

(57) ABSTRACT

Methods and apparatus for forming a web of heat shrunk plastic mesh are disclosed by the present application. In a method of forming a web of heat shrunk plastic mesh, a plurality of slits are cut in a plastic film. The cut plastic film is heated such that the plastic film shrinks and forms the heat shrunk plastic mesh. A machine for forming a heat shrunk plastic mesh includes a supply of plastic film, a cutting module, and a heat shrinking unit. The cutting module receives plastic film from the supply and cuts a plurality of slits in the plastic film. The heat shrinking unit receives the plastic film from the cutting module and heats the cut plastic film such that the plastic film shrinks and forms a plastic mesh.

### RELATED APPLICATIONS

This application claims priority to and the benefit of U.S. Provisional Patent Application No. 61/931,155, filed on Jan. 24, 2014, which is incorporated herein by reference in its entirety.

### TECHNICAL FIELD

This application relates generally to packaging and in particular to a heat shrunk plastic mesh, and methods and apparatus for forming a heat shrunk plastic mesh.

### BACKGROUND OF THE INVENTION

Various types of packaging are well known. Plastic mesh bags are one particular type of packaging that is often used to package items such as produce, for example, grapes or cherries. The mesh configuration allows air to circulate in the bag for ventilation of the produce.

### SUMMARY

The present application discloses a heat shrunk plastic mesh, and methods and apparatus for forming a heat shrunk plastic mesh. In one exemplary method of forming heat shrunk plastic mesh a plurality of slits are cut in a plastic film. The cut plastic film is heated such that the plastic film shrinks and forms the heat shrunk plastic mesh.

In one exemplary embodiment, a machine for forming a heat shrunk plastic mesh includes a supply of plastic film, a cutting module, and a heat shrinking unit. The cutting module receives plastic film from the supply and cuts a plurality of slits in the plastic film. The heat shrinking unit receives the plastic film from the cutting module and heats the cut plastic film such that the plastic film shrinks and forms a plastic mesh.

### BRIEF DESCRIPTION OF THE DRAWINGS

These and other features and advantages of the present invention will become better understood with regard to the following description and accompanying drawings in which:

FIG. 1 is a perspective illustration of a machine for converting a plastic film into a web of heat shrunk plastic mesh;

FIG. 2 is a view of a heat shrinking unit of the machine illustrated by FIG. 1;

FIG. 3 is a perspective view of the machine illustrated by FIG. 1 converting a plastic film into a web of heat shrunk plastic mesh;

FIG. 4 is a view of plastic film that has been cut such that heating the cut plastic film will convert the plastic film into a heat shrunk plastic mesh;

FIG. 5 is a view of a heat shrunk plastic mesh;

FIG. 6 is a view of the heat shrinking unit illustrated by FIG. 2 and heat shrunk plastic mesh being removed from the heat shrinking unit;

FIG. 7 is a schematic illustration of an exemplary cutting module for cutting plastic film to be heat shrunk to form a heat shrunk plastic mesh;

FIG. 8 is a view of the exemplary cutting module taken along lines 8-8 in FIG. 7;

FIG. 9 is a schematic illustration of an exemplary cutting module for cutting plastic film to be heat shrunk to form a heat shrunk plastic mesh;

FIG. 10 is a schematic illustration of an exemplary cutting module for cutting plastic film to be heat shrunk to form a heat shrunk plastic mesh;

FIG. 11 is a schematic illustration of an exemplary cutting module for cutting plastic film to be heat shrunk to form a heat shrunk plastic mesh;

FIG. 12A is an illustration of an exemplary embodiment of a cut plastic film to be heat shrunk to form a heat shrunk plastic mesh;

FIG. 12B is an illustration of an exemplary embodiment of a cut plastic film to be heat shrunk to form a heat shrunk plastic mesh;

FIG. 12C is an illustration of an exemplary embodiment of a cut plastic film to be heat shrunk to form a heat shrunk plastic mesh;

FIG. 12D is an illustration of an exemplary embodiment of a cut plastic film to be heat shrunk to form a heat shrunk plastic mesh;

FIG. 12E is an illustration of an exemplary embodiment of a cut plastic film to be heat shrunk to form a heat shrunk plastic mesh;

FIG. 12F is an illustration of an exemplary embodiment of a cut plastic film to be heat shrunk to form a heat shrunk plastic mesh; and

FIG. 12G is an illustration of an exemplary embodiment of a cut plastic film to be heat shrunk to form a heat shrunk plastic mesh.

### DETAILED DESCRIPTION

The present application relates to heat shrunk plastic mesh, and methods and apparatus for forming heat shrunk plastic mesh.

The heat shrunk plastic mesh is particularly useful for packaging various types of consumer products including, but not limited to, fresh produce, such as cherries, grapes, apples, and so forth.

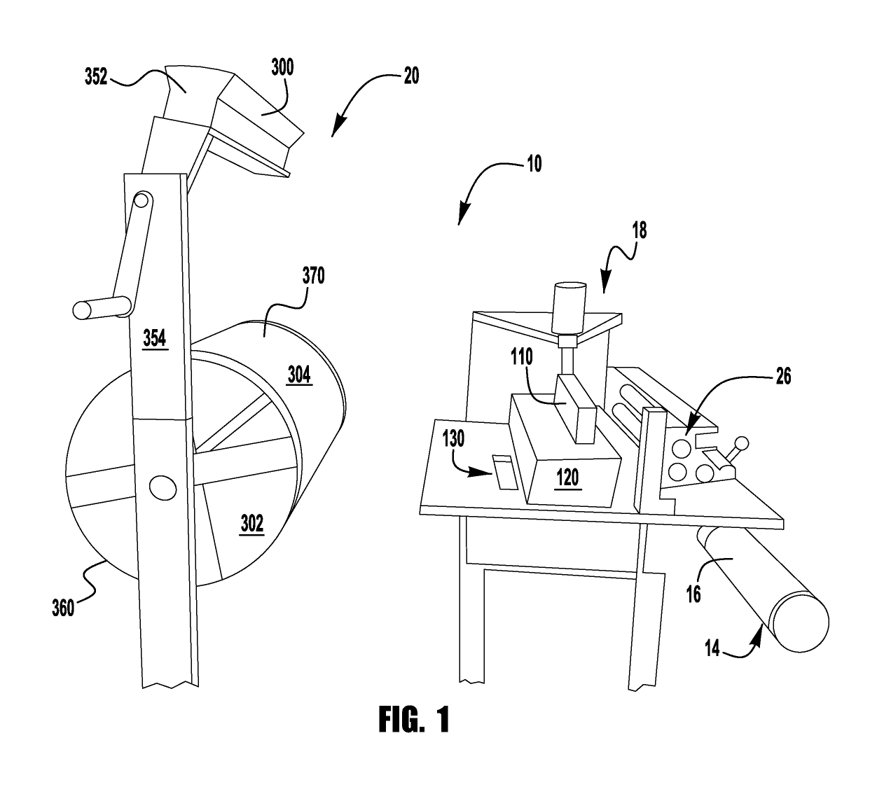

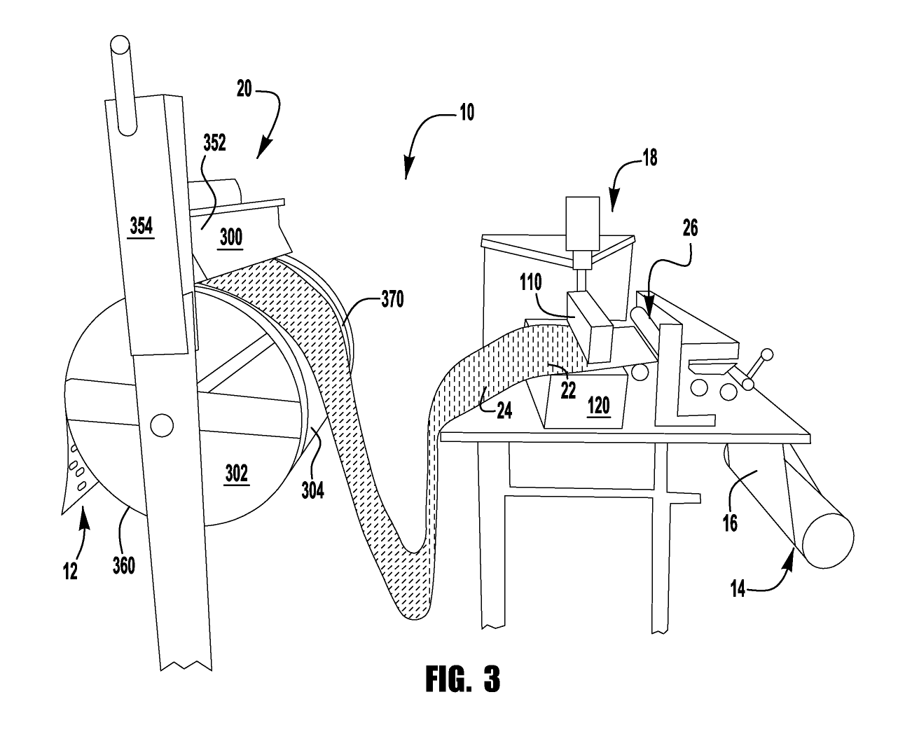

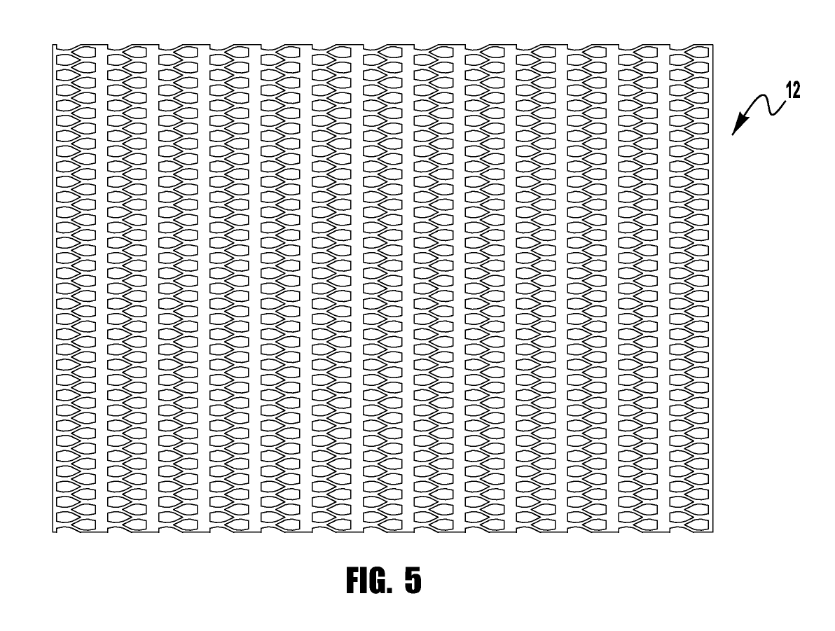

Referring to FIG. 1, an exemplary embodiment of a machine 10 for forming a heat shrunk plastic mesh 12 (See FIGS. 3, 5) is shown. The illustrated machine 10 includes a supply 14 of plastic film 16, a cutting module 18, and a heat shrinking unit 20. As shown in FIG. 3, the cutting module 18 receives plastic film 16 from the supply 14 and cuts a plurality of slits 22 in the plastic film 16. The heat shrinking unit 20 receives cut plastic film 24 from the cutting module 18 and heats the cut plastic film 24 such that the cut plastic film 24 shrinks and forms a heat shrunk plastic mesh 12.

The supply 14 of plastic film 16 can take a wide variety of different forms. In the illustrated embodiment, the supply 14 of plastic film 16 is a roll. The plastic film 16 may also be provided in a folded state. The illustrated uncut web of plastic film 16 is a single ply, however any number of plies may be cut. In an embodiment where the plastic film 16 comprises two or more plies, the plies may be joined to each other in any number of locations. For example, in certain embodiments, the plastic film 16 comprises a web of preformed bags. The plastic film 16 may take a wide variety of different forms. The plastic film 16 may be any plastic material that shrinks when heat is applied to the plastic. Examples of suitable plastics include, but are not limited to PVC, polyolefin, polyethylene, polypropylene, and the like.

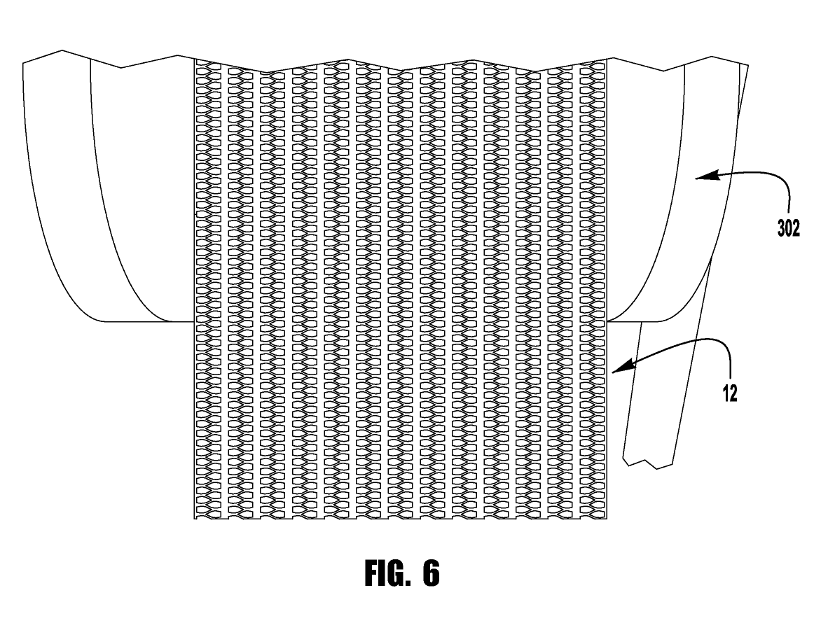

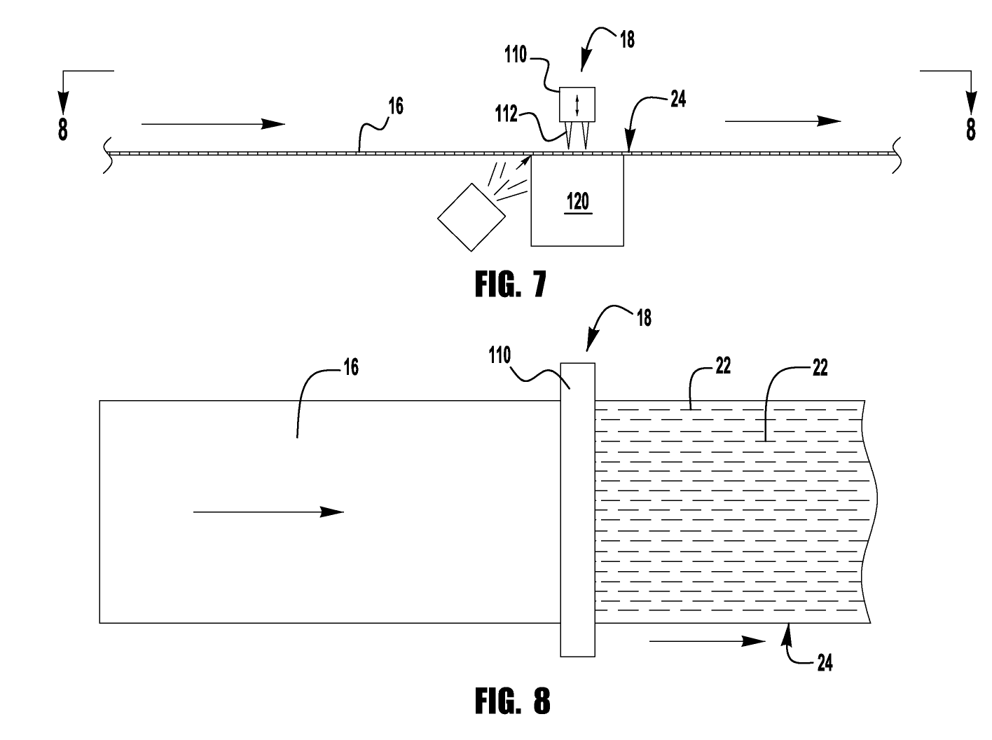

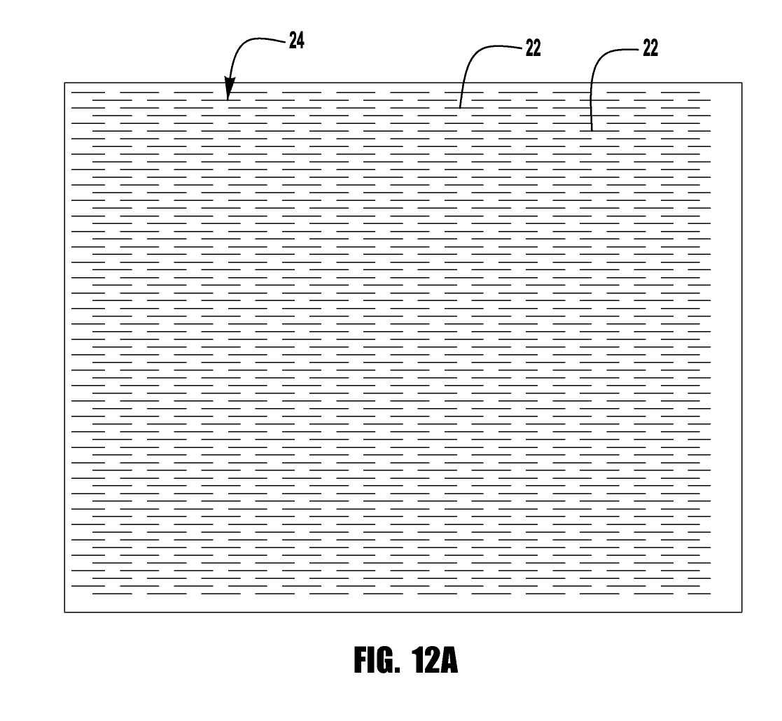

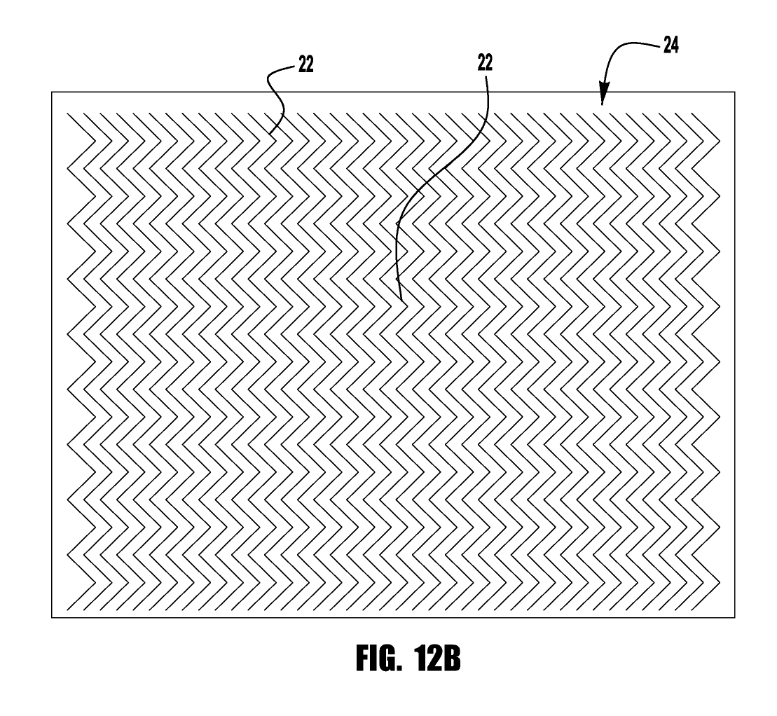

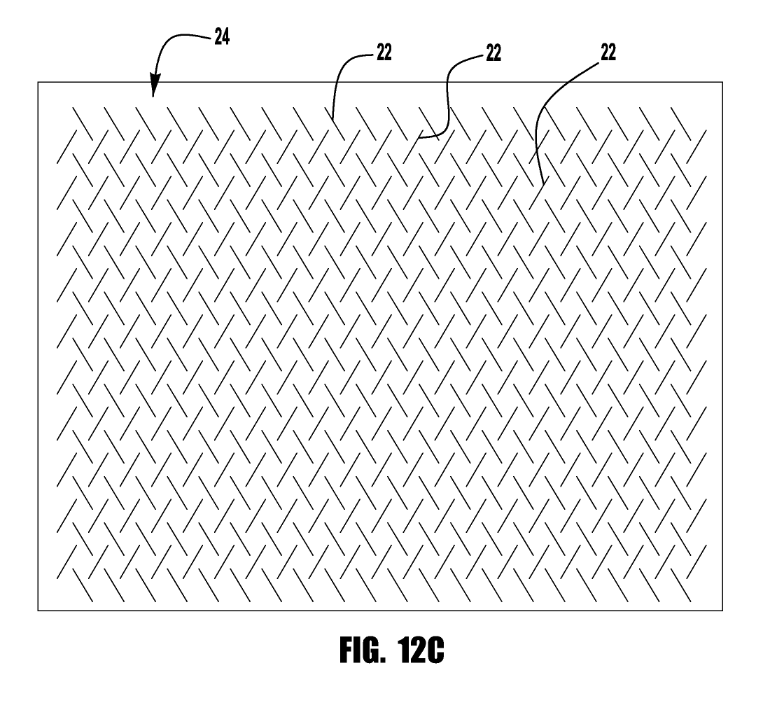

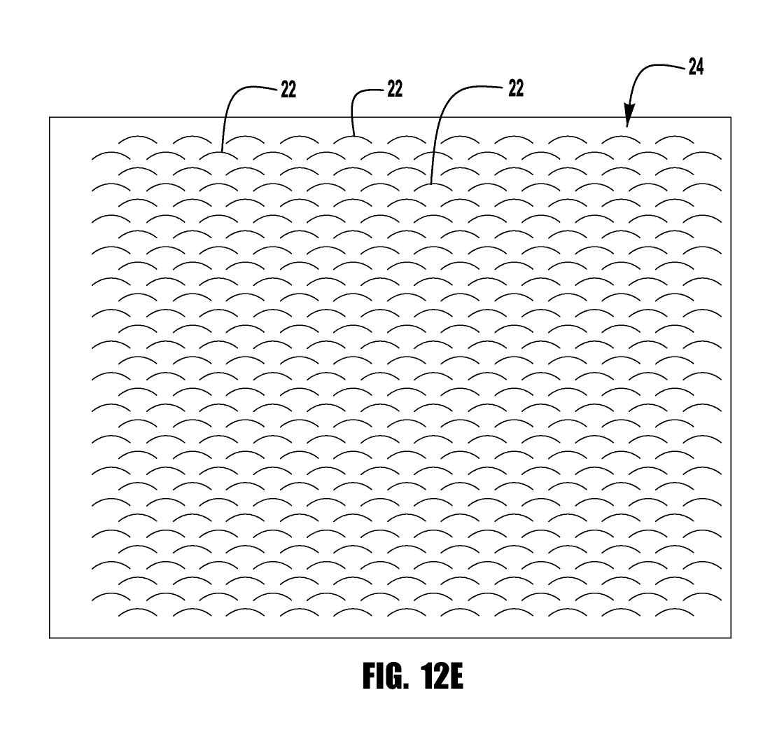

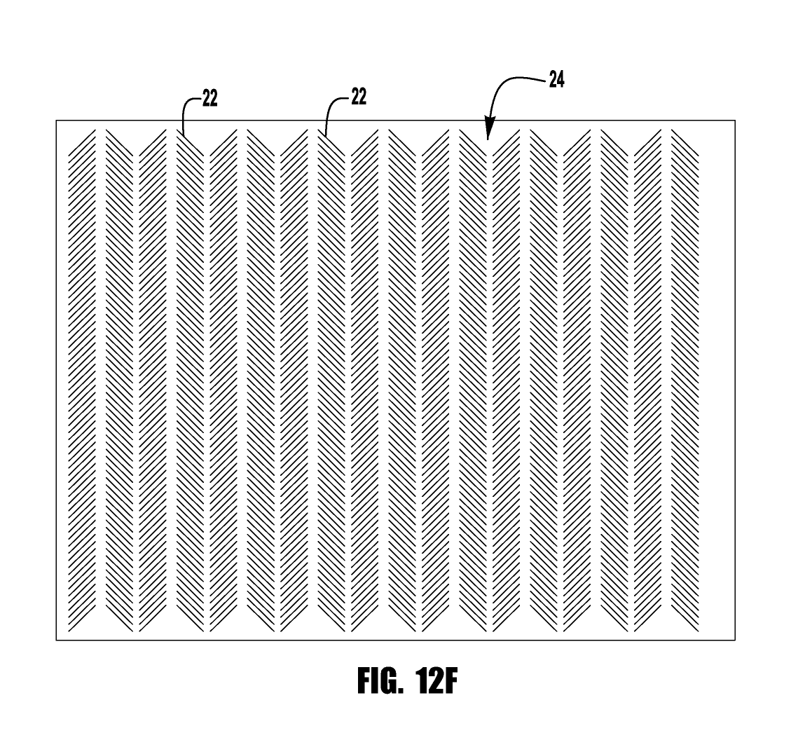

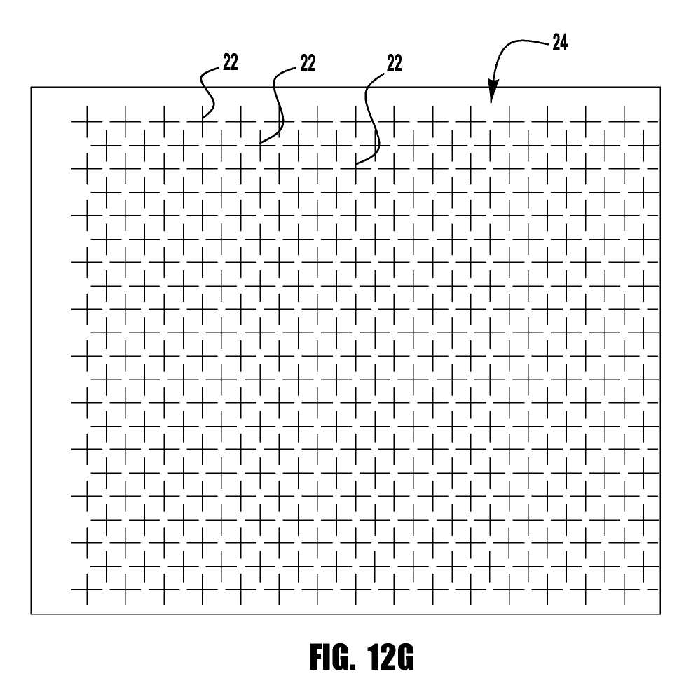

In an exemplary embodiment, the plastic film 16 is fed to the cutting module 18 by a pair of driven nip rollers 26. The cutting module 18 receives plastic film 16 from the supply 14 via the nip rollers 26 and cuts a plurality of slits 22 in the plastic film 16. The cutting module 18 can take a wide variety of different forms. As seen in FIGS. 7 and 8, the cutting module 18 includes a movable cutter 110 having a plurality of spaced apart cutting blades 112. The cutting blades 112 may be configured in a variety of ways to provide a variety of slit arrangements and predetermined slit patterns. In certain embodiments, the cutting blades 112 can be configured to form slits 22 in the plastic film 16 corresponding to a machine direction, or a direction of travel of the plastic film 16 (as indicated by the directional arrows), as seen in FIG. 8. In certain other embodiments, the cutting blades 112 are configured to form slits 22 in the film 16 of preformed bags corresponding to a cross direction, or perpendicular to the direction of travel of the film 16 (as indicated by the directional arrows). FIGS. 12A-12G illustrate several different possible slit arrangements and patterns.

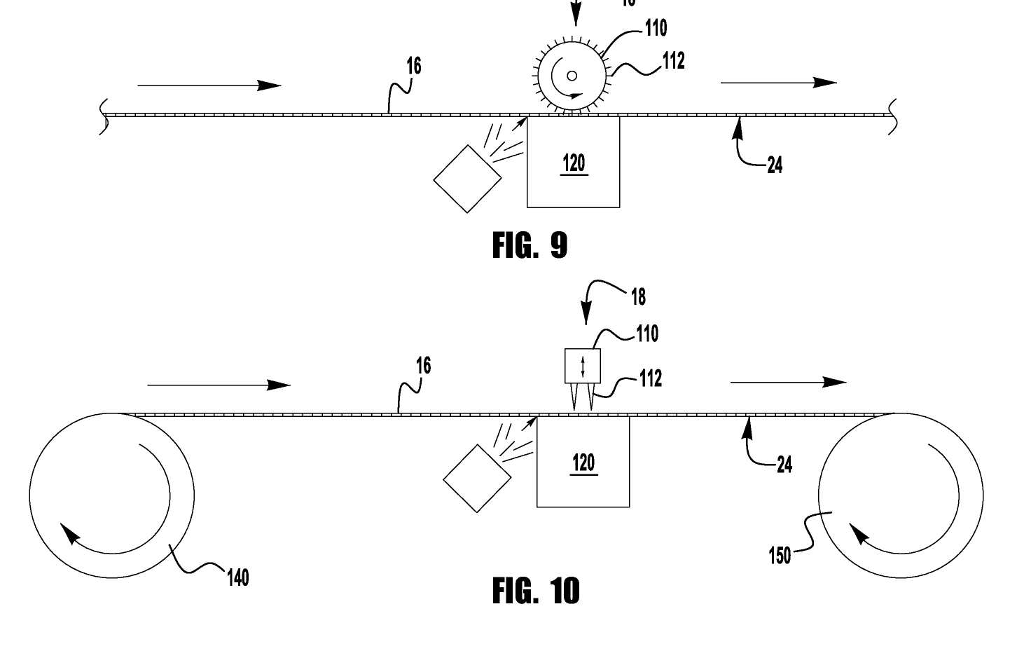

The movable cutter 110 may operate in a number of ways. As seen in FIG. 7, in certain embodiments, the movable cutter 110 is configured to move the plurality of cutting blades 112 with a linear reciprocating motion (i.e., up and down) to form the plurality of spaced apart rows of slits 22 in the plastic film 16. Alternatively, in certain embodiments, the movable cutter 110 is configured as a cutting roll having a plurality of spaced apart cutting blades 112 circumferentially arranged on the cutting roll, as seen in FIG. 9. Thus, in the exemplary movable cutter 110 illustrated in FIG. 9, the movable cutter 110 rotates the plurality of cutting blades 112 to form the plurality of spaced apart rows of slits 22 in the plastic film 16.

The cutting module 18 also includes a web support 120, as seen in FIGS. 1, 3, 7, and 9-11. The web support 120 provides support to the plastic web 16 as the movable cutter 110 forms slits in the plastic film 16. The web support 120 may be formed from a wide variety of materials. For example, the web support 120 can comprise a foam material, a rubber material, or a plastic material. The web support 120 should have a level of resiliency, but should not be too hard as to cause premature wear of the cutting blades 112.

With reference to FIGS. 7, 9, and 10, the cutting module 18 may include an optional blower 130. As the movable cutter 110 forms slits 22 in the plastic film 16, the plastic film 16 has a tendency to adhere to the web support 120. The blower 130 functions to separate the slit plastic film 16 from the web support 120, which helps reduce possible resistance created by adherence of the plastic film 16 to the web support 120. As illustrated in FIGS. 7, 9, and 10, the blower 130 may be positioned before the web support 120, such that the uncut plastic film 16 moves over the blower 130 before being cut. The blower 130 may also be positioned after the web support 120, as illustrated in FIG. 1. With reference to FIG. 1, the blower 130 may be mounted below a flat top of the cutting module 18. In certain embodiments, the blower 130 may be incorporated into the web support 120 to blow air through vents or pores in the web support 120.

The heat shrinking unit 20 can take a wide variety of different forms. The heat shrinking unit 20 can be any arrangement that heats the cut plastic film 24 and maintains the cut plastic film 24 in a substantially flat or unwrinkled condition as the cut plastic film 24 shrinks to form the heat shrunk plastic mesh 12. In an exemplary embodiment, the heat shrinking unit 20 includes a heater 300 and a plastic film conveyor 302.

The heater 300 can take a wide variety of different forms. Any heat source capable of providing heat to the plastic film 16 to shrink the film can be used. In an exemplary embodiment, the heater 300 is configured to heat the plastic film 16 uniformly across the width of the plastic film 16. In another embodiment, the heater 300 is configured to heat the plastic film 16 non-uniformly to shrink different portions of the plastic film 16 at different rates. The heater 300 can provide radiant heat, convective heat, and/or conductive heat to the plastic film. In the illustrated embodiment, the heater 300 is spaced apart from the plastic film conveyor 302, such that the plastic film 16 passes between the conveyor 302 and the heater 300.

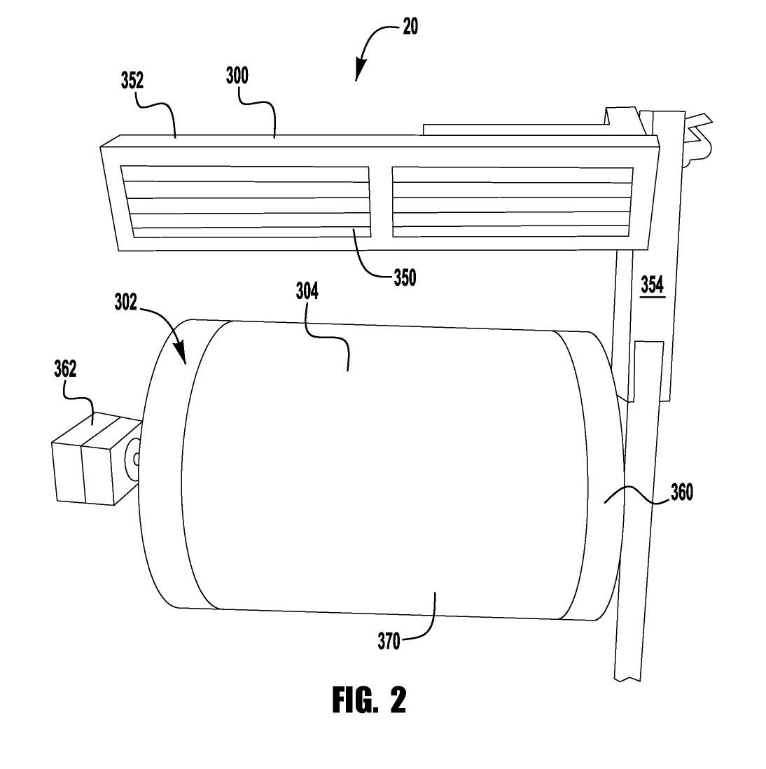

In the exemplary embodiment illustrated by FIG. 2, the heater 300 comprises a heating element 350 and a hood 352. The heater 300 is pivotally mounted to a post 354 such that the heater can be pivoted from a heating position (See FIG. 3) to a non-heating/spaced apart position (See FIGS. 1 and 2). The heater 300 may be arranged in any number of configurations to adjust the amount of heat applied to the cut plastic film 24, depending on the material used for the plastic film 16, and depending on the desired amount of shrinkage and rate of shrinkage. In certain embodiments, increasing the heat output of the heater 300 increases the shrink rate of the cut plastic film 16. In certain other embodiments, a lower temperature, and therefore lower shrink rate, may be desired to prevent damage to the cut plastic film 24.

The plastic film conveyor 302 can take a wide variety of different forms. The plastic film conveyor 302 can be any arrangement that moves the plastic film 16 past the heater 300. For example, the plastic film conveyor 302 can be a conveyor belt or a drum. In an exemplary embodiment, the conveyor 302 includes a low friction surface 304. The low friction surface 304 allows the plastic film 16 to uniformly shrink on the conveyor 302 to form a consistent heat shrunk plastic mesh 12. The low friction surface 304 allows the heat shrunk plastic mesh 12 to be easily removed from the conveyor 302 once the heat shrunk plastic mesh 12 cools. The low friction surface 304 can take a wide variety of different forms. Any surface that does not stick to the plastic film 16 can be used. For example, the low friction surface 304 may comprise a teflon material, a teflon coating, a ceramic coating, and the like.

The illustrated plastic film conveyor 302 includes a drum 360 that is rotatably mounted to the post 354. A motor 362 rotates the drum 360 to move the plastic film under the heater 300 to heat the plastic and form the heat shrunk plastic mesh 12. In the illustrated embodiment, the drum 360 has a low friction surface 304. In the illustrated embodiment, the low friction surface 304 is provided by a teflon belt 370 that is wrapped around the drum 360. In certain embodiments, the drum 360 may be hollow. The drum 360 may also be formed of heat conductive material or include vents in to facilitate cooling of the heat shrunk plastic mesh 12 and low friction surface 304.

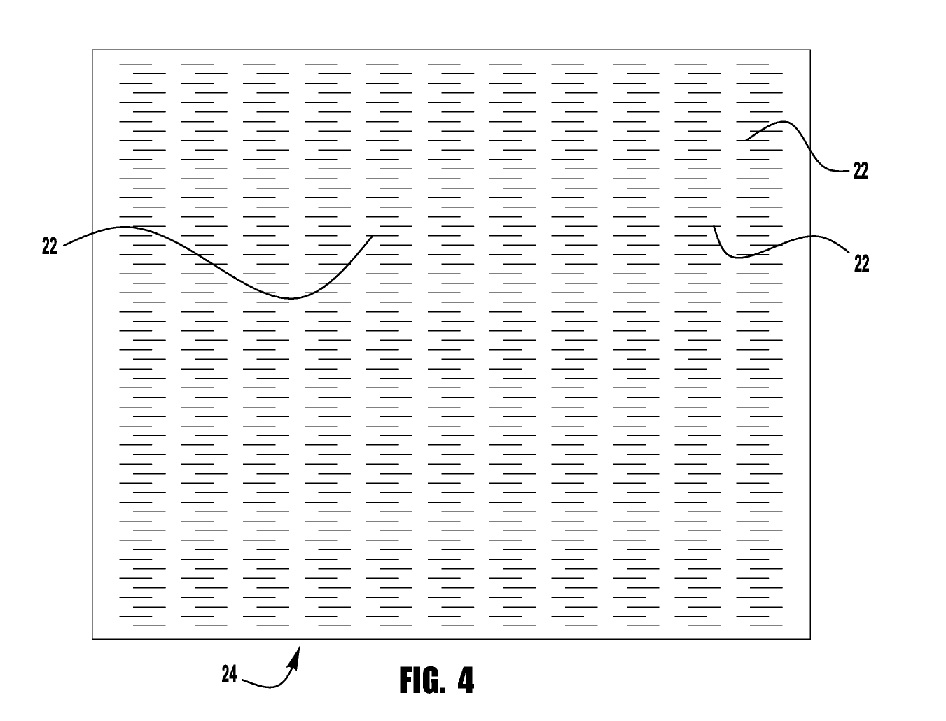

Referring to FIG. 3, the plastic film 16 is provided from the supply 14 to the cutting module 18. The cutting module 18 cuts the plastic film 16 to have the configuration of slits 22 illustrated by FIG. 4. The heat shrinking unit 20 receives cut plastic film 24 from the cutting module 18. The cut plastic film 24 is provided onto the teflon belt 370 on the drum 360. The motor 362 (FIG. 2) rotates the drum 360 to move the cut plastic film 24 under heater 300 to heat the plastic and form the heat shrunk plastic mesh 12. The heat shrunk plastic mesh 12 cools and is then separated from the teflon belt 370.

In the embodiment illustrated by FIG. 4, the pattern of slits 22 is repeating is but one of the many different possible slit patterns. As shown in FIG. 3, the plastic film 24 is heated by the heat shrinking unit 20 such that a cut plastic film 24 with slits 22 in the pattern illustrated by FIG. 4 shrinks to form a heat shrunk plastic mesh 12 as illustrated in FIG. 5. A wide variety of different cut patterns can be provided in the plastic film 16 to make a wide variety of different heat shrunk plastic mesh 12 configurations. FIGS. 12A-12G illustrate several different possible slit patterns.

In an exemplary embodiment, a method of cutting the plastic film 16 such that heating the cut plastic film 24 will convert the plastic film 16 into a heat shrunk plastic mesh 12 includes providing an uncut web of plastic film 16, as seen in FIGS. 3, 7, and 8. In another step of the exemplary method, a plurality of slits 22 or cuts is formed in the plastic film 16. The illustrated plurality of slits 22 are arranged in a plurality of spaced apart rows. In certain embodiments, the plurality of slits 22 are formed by a cutting module 18. The pattern of the plurality of slits 22 can take any form. FIGS. 12A-12G illustrate several different possible slit patterns. In yet another step of the exemplary method, the cut plastic film 24 is heated by a heat shrinking unit 20 such that it shrinks to form a heat shrunk plastic mesh 12.

Turning now to FIG. 10, in certain embodiments, the cutting module 18 may be configured as a standalone apparatus for forming a roll or supply of slit plastic film 24 that can be used with a standalone heat shrinking unit 20. As seen in FIG. 10, the cutting module 18 includes a movable cutter 110, a web support 120, and a blower 130 as previously described. An unslit plastic film 16 is provided on a supply roll 140, although in certain embodiments the plastic film 16 may be provided in a folded state. As illustrated in FIG. 10, the plastic film 16 is fed to the movable cutter 110 from the supply roll 140. After the plastic film 16 is fed through the movable cutter 110 and the plurality of slits 22 are formed in the plastic film 16, the slit plastic film 16 is collected on a rotatable collection roll 150. In certain embodiments, a portion of the plastic film 16 from the supply roll 140 may be wound around the collection roll 150 prior to feeding the remainder of the plastic film 16 to the movable cutter 110. In addition, the rotation of the collection roll 150 places tension on the plastic film 16 and facilitates feeding the plastic film 16 through the movable cutter 110 of the cutting module 18.

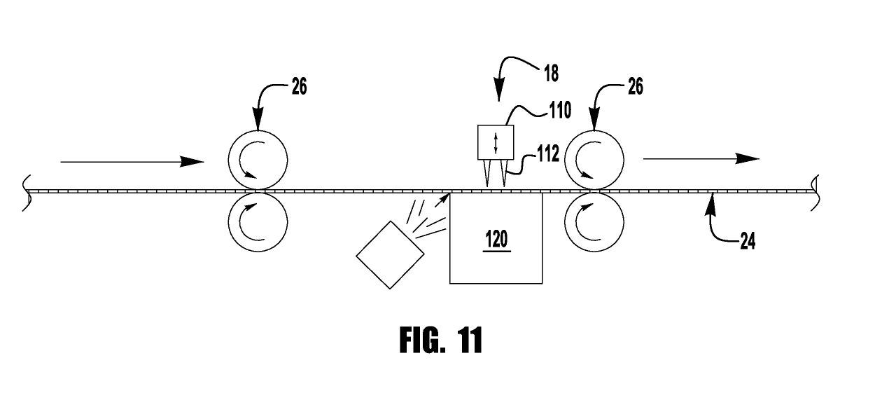

Referring now to FIG. 11, in certain embodiments the cutting module 18 may be configured as an in-line film cutting device that may be used, for example, in the machine illustrated by FIG. 1. The cutting module 18 includes a movable cutter 110, a web support 120, and a blower 130 as previously described. In addition, in certain embodiments, the cutting module 18 includes one or more pairs of nip rollers 26 that are counter rotated to feed the plastic film 16 through the cutting module 18.

Although the methods disclosed herein have been described with a particular order of steps, any one or more of the steps may be omitted and/or the order of the steps may be changed without departing from the spirit and the scope of the disclosed methods. Moreover, any one or more of the steps may be carried out manually or via an automated process utilizing various packaging machines and equipment known to those of skill in the art.

It should be understood that the embodiments discussed above are representative of aspects of the invention and are provided as examples and not an exhaustive description of implementations of an aspect of the invention.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention; however, such values and ranges are not to be construed in a limiting sense and are intended to be critical values or ranges only if so expressly stated.

What is claimed is:

1. A method of forming web of heat shrunk plastic mesh comprising:
cutting a plurality of slits in a plastic film; and
heating the cut plastic film such that the plastic film shrinks and forms a plastic mesh.

2. The method of claim 1, further comprising providing an uncut web of plastic film.

3. The method of claim 1, further comprising cooling the plastic mesh.

4. The method of claim 1, further comprising collecting the plastic mesh on a rotatable collection roll.

5. A machine for forming a heat shrunk plastic mesh comprising:
a supply of plastic film;
a cutting module that receives plastic film from the supply and cuts a plurality of slits in the plastic film; and
a heat shrinking unit that receives the cut plastic film from the cutting module and heats the cut plastic film such that the cut plastic film shrinks and forms a plastic mesh.

6. The machine of claim 5, wherein the supply of plastic film comprises a supply roll.

7. The machine of claim 5, wherein the supply of plastic film comprises plastic film in a folded state.

8. The machine of claim 5, wherein the supply of plastic film comprises plastic film with two or more layers.

9. The machine of claim 8, wherein the two or more layers of plastic film are joined in one or more locations.

10. The machine of claim 5, wherein the cutting module further comprises a backing material.

11. The machine of claim 10, wherein the cutting module further comprises a blower.

12. The machine of claim 5, wherein the cutting module further comprises a reciprocating cutter.

13. The machine of claim 5, wherein the cutting module further comprises a rotating cutter wheel.

14. The machine of claim 5, wherein the heat shrinking unit further comprises a heat source moveable between a heating position and a non-heating position.

15. The machine of claim 5, wherein the cut plastic film is maintained in a substantially flat condition as the cut plastic film shrinks to form the plastic mesh.

16. The machine of claim 5, further comprising rollers disposed between the supply and the cutting module to feed the plastic film into the cutting module.

17. The machine of claim 5, further comprising rollers disposed between the cutting module and the heat shrinking unit to feed the plastic film into the cutting module.

18. The machine of claim 5, further comprising a plastic film conveyer.

19. The machine of claim 5, further comprising a rotatable collection roll.
